(19) United States
(12) Patent Application Publication
(10) Pub. No.: US 2018/0319997 A1
(43) Pub. Date: Nov. 8, 2018

(54) Pretreatment of Magnesium Substrates

(71) Applicant: PPG Industries Ohio, Inc., Cleveland, OH (US)

(72) Inventors: Nathan J. Silvernail, Allison Park, PA (US); Adam Kolcun, Oakmont, PA (US); Brian Okerberg, Gibsonia, PA (US); Thor G. Lingenfelter, Evans City, PA (US); Roy E. Dean, Natrona Heights, PA (US)

(21) Appl. No.: 16/033,809

(22) Filed: Jul. 12, 2018

Related U.S. Application Data
(62) Division of application No. 14/184,998, filed on Feb. 20, 2014, now abandoned.

(51) Int. Cl. C09D 5/08; B05D 3/00

(52) U.S. Cl. CPC C09D 5/08; B05D 3/002

(57) ABSTRACT

A method and composition for pretreating magnesium substrates prior to the application of a protective and/or decorative surface coating is disclosed. The pretreatment composition comprises (a) a compound containing at least 4 phosphorus acid groups and (b) a soluble alkaline earth salt.

### FIELD OF THE INVENTION

The present invention relates to compositions for pretreatment of magnesium substrates prior to the application of a protective and/or decorative coating.

### BACKGROUND OF THE INVENTION

Magnesium is an attractive metal in construction. It has a higher strength-to-weight ratio than aluminum and steel making it useful for the construction of various devices such as automobiles and consumer electronics. Magnesium, however, when unprotected oxidizes and exhibits relatively poor adhesion to subsequently applied coatings. To deal with these issues, magnesium is typically pretreated before coating with a chromium compound such as chromic acid to inhibit oxidation to promote adhesion. While effective, the chromium compounds nonetheless are undesirable because of their toxicity and the attendant problems of disposal. Hence a replacement for chromium in the pretreatment of magnesium substrates is desirable.

### SUMMARY OF THE INVENTION

The present invention provides a composition for treating magnesium substrates prior to applying a coating to the surface of the magnesium substrate. The composition comprises a compound having at least 4 phosphorus acid groups and a soluble alkaline earth salt.

The invention also provides a method for treating a magnesium substrate by contacting the magnesium substrate with the composition described above.

### DETAILED DESCRIPTION

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa.

The compound having at least 4 phosphorus acid groups can be a naturally occurring material such as phytic acid with 6 phosphorus acid groups or can be a synthetic material such as that obtained by reacting a polyol containing at least 4 hydroxyl groups such as pentaerythritol, dipentaerythritol or sorbitol with a stoichiometric amount of phosphoric acid (1 mole polyol/4 moles phosphoric acid). Besides phosphoric acid that would form the phosphate esters, organic phosphoric acids could also be used.

The alkaline earth salt can be a salt of calcium or strontium such as calcium nitrate, strontium nitrate and calcium chloride that is soluble in the treatment composition.

A source of fluoride can be present in the treatment composition and could be that derived from hydrofluoric acid, ammonium fluoride, sodium fluoride, ammonium hydrogen fluoride and sodium hydrofluoride that provide a source of free fluoride or can come from a complex metal fluoride salt such as tetrafluoroboric acid or hexafluorozirconic acid.

The above-mentioned ingredients are typically added to water with low shear mixing to form a solution of the aqueous pretreatment composition. The composition containing the at least 4 phosphorus acid groups is usually present in amounts of 0.01% to 20%, typically 0.1 to 2 percent by weight, and the alkaline earth salt is present in amounts of 0.01% to 5%, typically 0.1 to 1 percent by weight. The percentages by weight being based on total weight of the aqueous pretreatment composition. The fluoride is present in amounts of 0 to 500 parts per million (ppm), typically from 10 to 40 ppm.

Optional ingredients such as surfactants and defoamers can be present the composition and, when present, are present in amounts up to 0.01 to 5 percent by weight based on weight of the aqueous pretreatment composition.

The pH of the treatment composition can vary between 1 and 10, typically 1 to 5 and can be adjusted with sodium or potassium hydroxide.

Besides magnesium, alloys of magnesium such as magnesium zinc and magnesium aluminum alloys can be pretreated in accordance with the invention. Also, substrates containing more than one metal such as also containing aluminum surfaces and steel surfaces such as metal surfaces associated with automobiles can be contacted with the aqueous pretreatment compositions of the invention. Although these metal surfaces may need to be pretreated with other compositions for surface protection and adhesion to subsequently applied coatings, the compositions of the invention do not detrimentally affect the properties of these metals.

The aqueous pretreatment compositions can be contacted with the magnesium substrate by conventional means such as spraying, brushing, roll coating or immersion techniques. The temperature of the composition is usually from 20 to 49° C., typically 20 to 37° C., at the contact time from 5 seconds to 20 minutes, typically 1 to 5 minutes.

Prior to contact, the magnesium substrate is typically cleaned by physical or chemical means followed by rinsing with water. After contact, the pretreated substrate is separated from the treatment area and rinsed with water and dried typically at 27 to 49° C. for 1 to 5 minutes.

The pretreated substrate is then subsequently coated with a protective and/or decorative surface coating such as a powder coating, an anionic or cationic electrodeposition paint, a powder coating, and a liquid paint applied by non electrophoretic techniques such as an organic solvent based paint or a water based paint either of which may be of high solids.

### EXAMPLES

The invention is further illustrated by the following non-limiting examples. All parts are by weight unless otherwise indicated.

### Example 1

### Comparative

AZ31B-H24 magnesium alloy panels were obtained from Metalmart International (Commerce, Calif.) for testing. The panels were cleaned and degreased for two minutes at 120T (49° C.) in alkaline cleaner and rinsed with deionized water for thirty seconds. The alkaline cleaner was comprised of 1.25 wt % Chemkleen 2010LP (PPG Industries, Inc., Cleveland, Ohio) and 0.13 wt % Chemkleen 181ALP (PPG Industries, Inc.) in deionized water.

A composition for treating the cleaned and degreased panels was prepared by adding 122g of a phytic acid solution (40-50% w/w in water, Acros-Organics) to 10.8 l of deionized water. The pH of the bath was adjusted to 2 using potassium hydroxide (45% w/w in water). The nominal phytic acid level in the bath was 0.5% by weight.

The panels were immersed in the composition for 2 minutes at ambient temperature, rinsed with deionized water for 30 seconds, and dried with hot air (130° F. [54° C.]).

### Example 2

### Comparative

The treatment procedure described in Example 1 was followed for this Example.

The treatment composition was prepared by adding 122 g of phytic acid solution and 9.5 g of ammonium bifluoride powder (Fischer Chemicals) to 10.0 l of deionized water. The pH of the bath was adjusted to 2.5 using potassium hydroxide. The nominal levels of phytic acid and free fluoride were 0.5% and 100 ppm, respectively.

### Example 3

### Comparative

The treatment procedure described in Example 1 was followed for this Example.

The treatment composition was prepared by adding 122 g of phytic acid solution and 19.1 g of ammonium bifluoride powder to 10.8 l of deionized water. The pH of the bath was adjusted to 2.5 using potassium hydroxide. The nominal levels of phytic acid and free fluoride were 0.5% and 200 ppm, respectively.

### Example 4

The treatment procedure described in Example 1 was followed for this Example.

The treatment composition was prepared by adding 122 g of phytic acid solution and 100 g of calcium chloride dihydrate powder (Fischer Chemicals) to 10.8 l of deionized water. The pH of the bath was adjusted to 2 using potassium hydroxide. The nominal levels of phytic acid and calcium were 0.5% and 0.25%, respectively.

### Example 5

The treatment procedure described in Example 1 was followed for this Example.

The treatment composition was prepared by adding 122 g of phytic acid solution, 40g of calcium chloride dihydrate powder, and 22 g of tetrafluoroboric acid solution (50% w/w in water, Rieder-de Haen) to 10.8 l of deionized water. The pH of the bath was adjusted to 3 using potassium hydroxide. The nominal level of phytic acid was 0.5%, calcium was 0.1%, tetrafluoroboric acid was 0.1% and free fluoride was 20 ppm.

### Example 6

### Comparative

The treatment procedure described in Example I was followed for this Example.

The treatment composition was prepared by adding 18.2 g hexafluorozirconic acid (45% w/w in water), 20 g copper nitrate (2% w/w in water) and 15 g Chemfos AFL (PPG Industries, Inc.) to 18.2 l of water. The pH was adjusted to 4.7 with Chemfil Buffer (an alkaline buffering solution, PPG Industries, Inc.). The zirconium level was approximately 200 ppm, the copper was 20 ppm, and free fluoride was 50 ppm.

### Example 7

### Comparative

The treatment procedure described in Example 1 was followed for this Example.

The treatment composition was prepared by adding 18.2g hexafluorozirconic acid (45% w/w in water), 20g copper nitrate (2% w/w in water) and 16 g Chemfos AFL (PPG Industries, Inc.) to 18.2 l of water. The bath was used at the make-up pH, 2. The zirconium level was approximately 200 ppm, the copper was 20 ppm, and free fluoride was 50 ppm.

Prior to testing, all panels were painted via electrodeposition using a cathodic epoxy paint Powercron 6000CX from PPG Industries. The paint was deposited using a voltage of approximately 200V, arid following which they were cured for 25 minutes at 350° F. (177° C.).

Table I below contains the results of using different bath formulations to coat the studied substrate in accordance with the invention. The salt spray testing NSS and cyclic corrosion GMW14872 results indicate a strong increase in corrosion resistance over phytic acid alone and a standard zirconium coating by using the novel bath formulations described before.

TABLE I

| | 500 Hours NSS¹ | | 40 cycles GMW14872² | |
|---|---|---|---|---|
| | Avg | Max | Avg | Max |
| Example | (mm creep) | (mm creep) | (mm creep) | (mm creep) |
| 1 | N/A³ | N/A³ | 8 | 11.6 |
| 2 | 5.4 | 6.8 | 10.3 | 12.2 |
| 3 | 8.2 | 11.6 | 5.8 | 7.9 |
| 4 | 8.7 | 12.4 | 0.8 | 1.7 |
| 5 | 5.9 | 7.3 | 1.6 | 4.3 |
| 6 | 13.9 | 22.1 | 23.1 | 35 |
| 7 | 5.8 | 8.5 | 12.3 | 14.1 |

¹Salt spray corrosion testing per ASTM B117.
²Cyclic corrosion testing by rotating test panels through a salt solution, room temperature dry, humidity and low temperature in accordance with General Motors Test Method GMW14872.
³Panels were removed from salt spray test due to severe corrosion, affecting the integrity of the panel.

Whereas particular embodiments of this invention have been described above for purposes of illustration, it will be evident to those skilled in the art that numerous variations of the details of the present invention may be made without departing from the invention as defined in the appended claims.

Although various embodiments of the invention have been described in terms of “comprising”, embodiments consisting essentially of or consisting of are also within the scope of the present invention.

1. An aqueous composition for treating magnesium substrates prior to applying a surface coating thereon, the composition comprising:
(a) a compound containing at least four phosphorus acid groups,
(b) a soluble alkaline earth salt, and
(c) a source of fluoride.

2. The aqueous composition of claim 1 in which (a) is phytic acid or a salt thereof.

3. The aqueous composition of claim 1 in which the source of fluoride is selected from the group consisting of HF, NH4F, and NH₄F₂.

4. The aqueous composition of claim 1 in which (b) is a calcium salt.

5. A method for treating a magnesium substrate comprising contacting the magnesium substrate with the aqueous composition of claim 1.

6. The method of claim 5 in which after the magnesium substrate has been contacted, the substrate is coated with a protective coating.

7. The method of claim 6 in which the protective coating comprises an organic solvent based coating, a powder coating, or an electrodeposited coating.

8. A consumer electronic device that has been treated with the aqueous composition of claim 1.
